(19) United States
(12) Patent Application Publication
(10) Pub. No.: US 2013/0216299 A1
(43) Pub. Date: Aug. 22, 2013

(54) ADJUSTABLE FIXATION OR LOCKING MEANS FOR TWO PARTS BY USE OF SLIDING HINGE

(71) Applicant: Vital Base AS, (US)

(72) Inventor: John Rune FURNES, Horsens (DK)

(73) Assignee: Vital Base AS, Hareid (NO)

(21) Appl. No.: 13/739,211

(22) Filed: Jan. 11, 2013

(30) Foreign Application Priority Data
Feb. 17, 2012 (EP) 12155875.3

(51) Int. Cl. F16B 12/00

(52) U.S. Cl. CPC F16B 12/00
USPC 403/83

(57) ABSTRACT

The present invention relates to an adjustable fixation or locking means for two parts or portions by use of sliding hinge. The parts or portions are to be used or utilized in furniture and/or human necessity products, such as e.g. different types of chairs, sofas, wheelchairs, etc.

The present invention relates to an adjustable fixation or locking means for two parts or portions by use of sliding hinge. The parts or portions are to be used or utilized in furniture and/or human necessity products, such as e.g. different types of chairs, sofas, wheelchairs, etc.

### BACKGROUND OF THE INVENTION

From U.S. Pat. No. 4,730,842 it is well known to use Velcro™ to fasten, in a wheelchair, two furniture parts together. In the wheelchair described in this patent publication a cushion is fastened to a seat portion by means of a pair of overlapping flexible supports having Velcro™ material thereon for joining the supports of varying degrees of overlap.

JP 2003153764 A relates to a cushion providing for retaining a sitting position of a wheelchair that does not give pain to the waist of a person sitting on the wheelchair and prevents the person from falling sideways and stabilizes the sitting position of the person. The cushion for retaining the sitting position is mounted to the backrest and the side plate portions of the wheelchair that can be provided with a chair cover. The cushion is made up of a waist pad removably mounted to the backrest portion, butting and retaining the waist of the sitting person, and a pair of side pads removably mounted to the side plates, butting and retaining the sides of the sitting person. The waist pad is stored in a cover, and Velcro™ fasteners, provided in the cover, are connected to corresponding Velcro™ fasteners provided in the backrest portion of the wheelchair, wherein the waist pad is mounted on the backrest portion. The side pads are stored in covers, and Velcro™ fasteners, provided in the covers, are connected to corresponding Velcro™ fasteners provided in the side plates of the wheelchair, wherein the side pads are mounted on the side plates.

WO 2009/031875 A1 teaches a mufti-functional system of blocks in a mufti-functional furniture product comprising a plurality of structural components or parts provided with strips of Velcro™ and thus enabling the same to be easily converted to produce different furniture configurations.

In other alternatives for connecting of two parts bolts, nuts, screws, clips, clamps, telescopic or ordinary arm elements, plywood plates, brackets, globe or toggle joints, or the like, are being used. If some of them could be adjusted, usually tools are required or needed.

Most of the known fixation or locking means for two parts or portions have several disadvantages, wherein some do not allow to be adjusted in relation to each other, others that are adjustable do not have a firm and good grasp or fixation in relation to each other and can easily be loosened up or be disconnected from each other or be movable in connected or fixed position, and another group thereof can easily break. Of course there are also some having any possible combination of the above-mentioned disadvantages and problems.

The present inventions solved these disadvantages and problems.

### SUMMARY OF THE INVENTION

It is an object of the present invention to provide an adjustable fixation or locking means for two parts or portions, producing or creating a non-stepwise and/or progressively adjustable regulation of said two parts or portions in relation to each other.

Another object of the present invention is to provide an adjustable fixation or locking means for two parts or portions, providing for a good and firm connection when the two parts or portions are in one of many fixed or connected positions.

Yet another object of the present invention is to provide an adjustable fixation or locking means for two parts or portions, providing for a substantially rigid and solid connection when the two parts or portions are in one of many fixed or connected positions.

It is a further object of the present invention to provide an adjustable fixation or locking means for two parts or portions, that is easy to adjust without any need for tools or other parts.

The present invention concerns also two framings or frame arrangements for the adjustable fixation or locking means and adapted to be used for the two parts or portions.

This is obtained by the independent claims according to the present invention.

Additional features of the invention are given in the dependent claims.

### SHORT DESCRIPTION OF THE DRAWINGS

FIG. 1A-1B show radial cross-sections of one embodiment of an adjustable fixation or locking means for two parts or portions;

FIG. 2A-2D show radial cross-sections of different positions of the fixation or locking means according to the embodiment in FIG. 1A-1B;

FIG. 3A-3C show radial cross-sections of different embodiments the fixation or locking means according to the present invention;

FIG. 4A-4D show in detail and in perspective different positions of two parts or portions incorporating the fixation or locking means according to the present invention;

FIG. 5A-5E show in perspective different positions of the two parts or portions, one base and at least one adjustable portion, incorporating the fixation or locking means according to the present invention; and

FIG. 6A-6B show two different embodiments of the present invention.

### DETAILED DESCRIPTION OF THE INVENTION

The present invention relates to an adjustable fixation or locking means for two parts or portions by use of sliding hinge means.

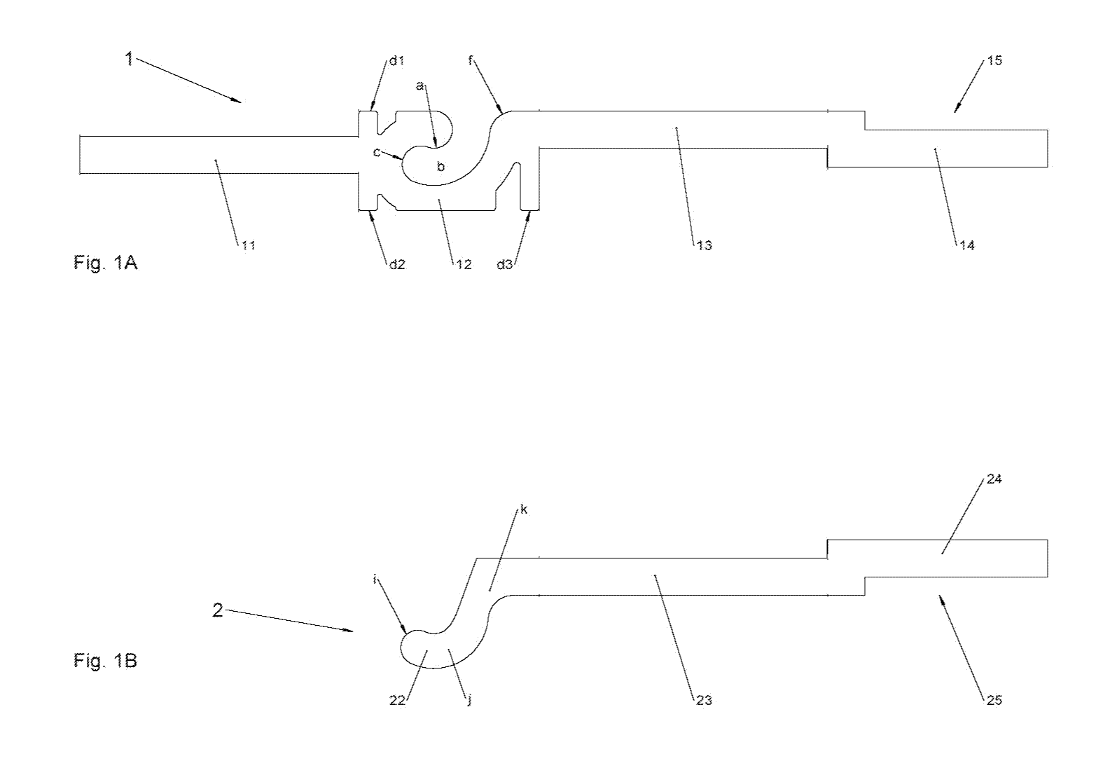

FIGS. 1A and 1B show radial cross-sections of one embodiment of an adjustable fixation or locking means for two parts or portions 111, 222 (e.g. a base and an adjustable portion) by use of sliding hinge means. The fixation or locking means comprises two profiles 1 and 2: one longitudinal base profile 1, shown in detail in FIG. 1A, comprising a longitudinal female locking part or section 12 connected, at least in one of its ends, to at least one longitudinal plate part or section 11, 13; and one adjustable longitudinal profile 2, shown in detail in FIG. 1B, comprising a longitudinal male locking part or section 22 connected, at one end, to a longitudinal plate part or section 23. The longitudinal female locking part or section 12 and the longitudinal male locking part or section 22 define the sliding hinge means 50.

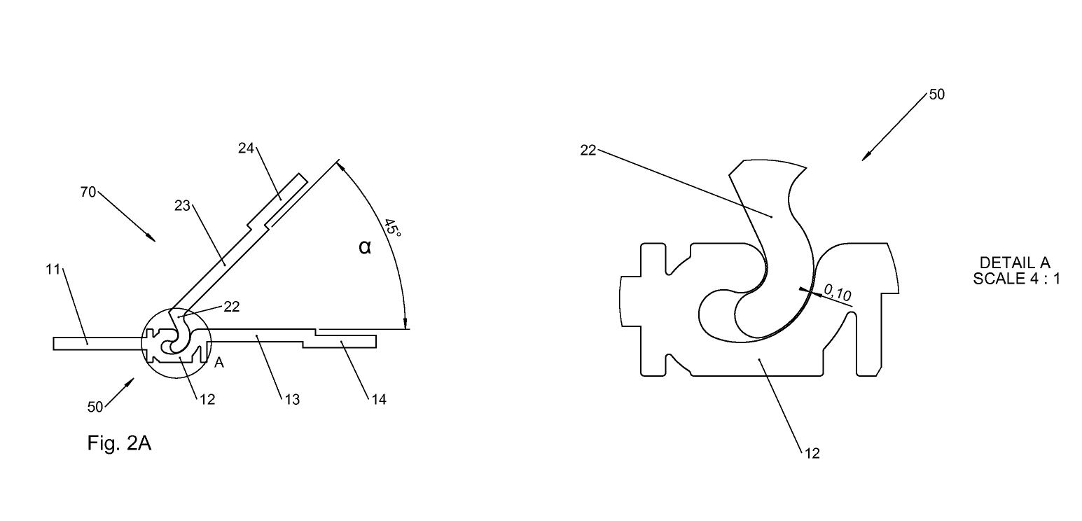

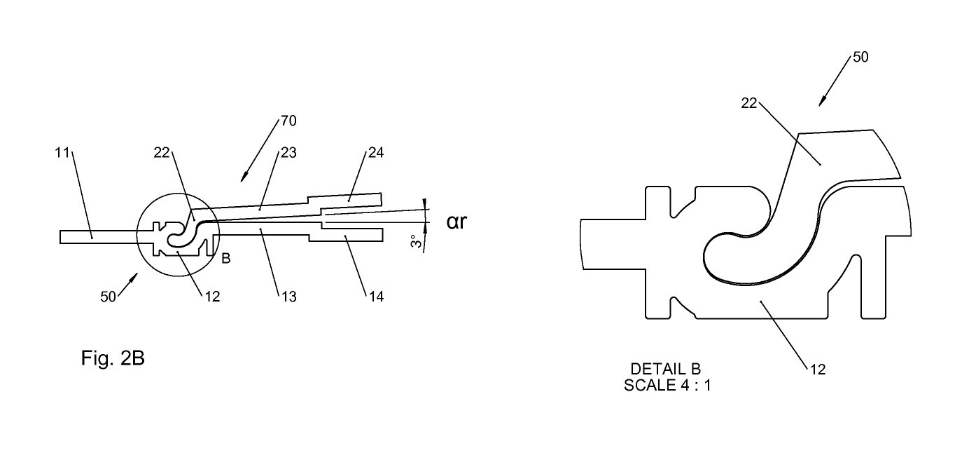

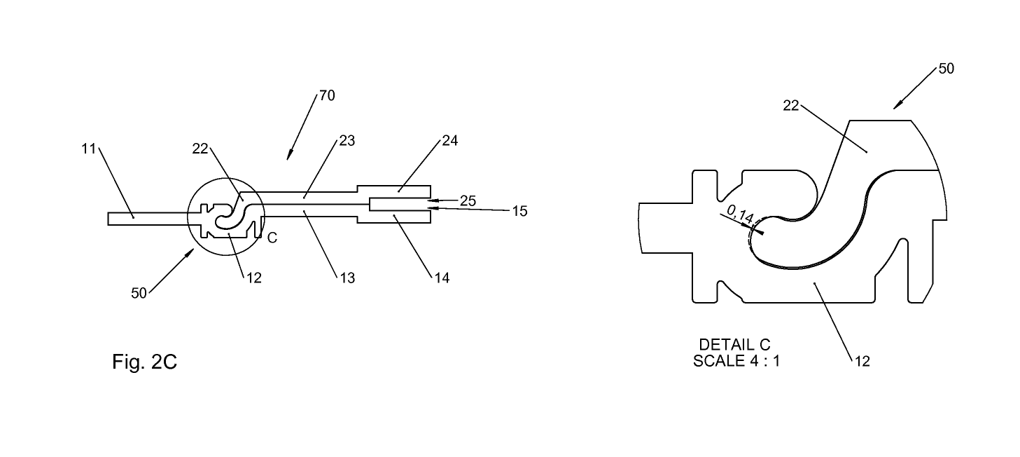

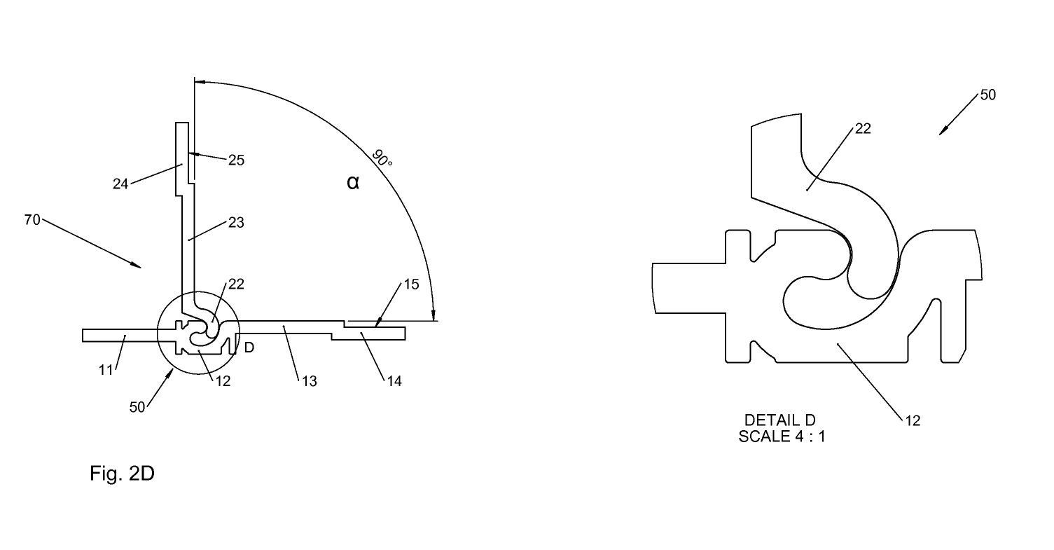

The fixation or locking means has three positions: a locked (shown e.g. in FIG. 2C), a loose or sliding (shown e.g. in FIG. 2A) and an open (shown e.g. in FIG. 2D) position.

According to one embodiment of the invention, as in FIG. 1A, the longitudinal female locking part or section 12 is a groove or recess, b, having a radial cross-section with a substantially J-shape or a shape substantially being in the form of a lower part of a hook. The groove or recess, b, has a bottom part, c, and a top bottom part, a.

According to the above-mentioned embodiment of the invention, as in FIG. 1B, the longitudinal male locking part or section 22 is a tongue having a radial cross-section with a shape substantially corresponding to the shape of the longitudinal female locking part or section 12 and geometrically fittable therein. The tongue has a base part, k, a hooked part, j, and a top or end part, i.

It is possible for the longitudinal plate parts or sections 13, 23 of the longitudinal profiles 1, 2, that are facing each other, to have arranged on their ends that are opposite to the sliding hinge means 50, a recessed part or section 14, 24 providing for sufficient room or space 15, 25 for rooming an additional fastening means 30 that is being easily fastened or unfastened, preferably without the necessity of any tool or tools. The additional fastening means 30 can be, and is not limited only thereto, at least one of: Velcro™, zipper, clamps, clips, or the like. What is important with the additional fastening means 30 is the function to facilitate easy fastening and/or unfastening of the two parts or portions 111, 222, preferably without the necessity of any tool or tools. Of course screws, bolts and nuts could be used, but then in this embodiment it is most possible that tool(s) will be needed or necessary in order to change to different positions of the adjustable part 222 in relation to the base part 111.

According to another embodiment of the invention the each other facing plate parts or sections 13, 23 (possibly 14, 24) can be all shaped or arranged in such a way that the additional fastening means 30 (e.g. Velcro™) can be arranged along the entire longitudinal direction for each respective profile 1, 2 or part/portion 111, 222 and at least onto some or onto the entire radial width of the respective each other facing plate part or section 13, 23 (possibly 14, 24). In this case parts 14, 24 can be regarded just as extensions of parts 13, 23, in other words parts 13 and 14, respectively parts 23, 24, will be just one longer part.

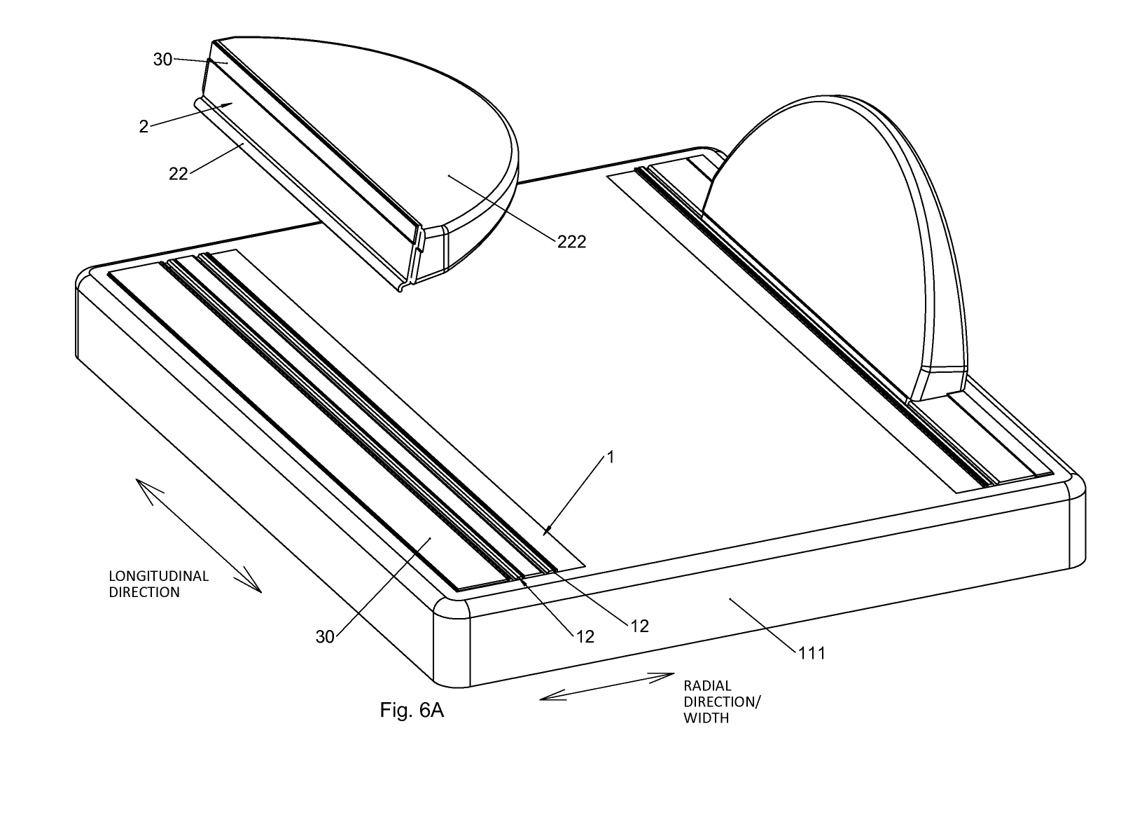

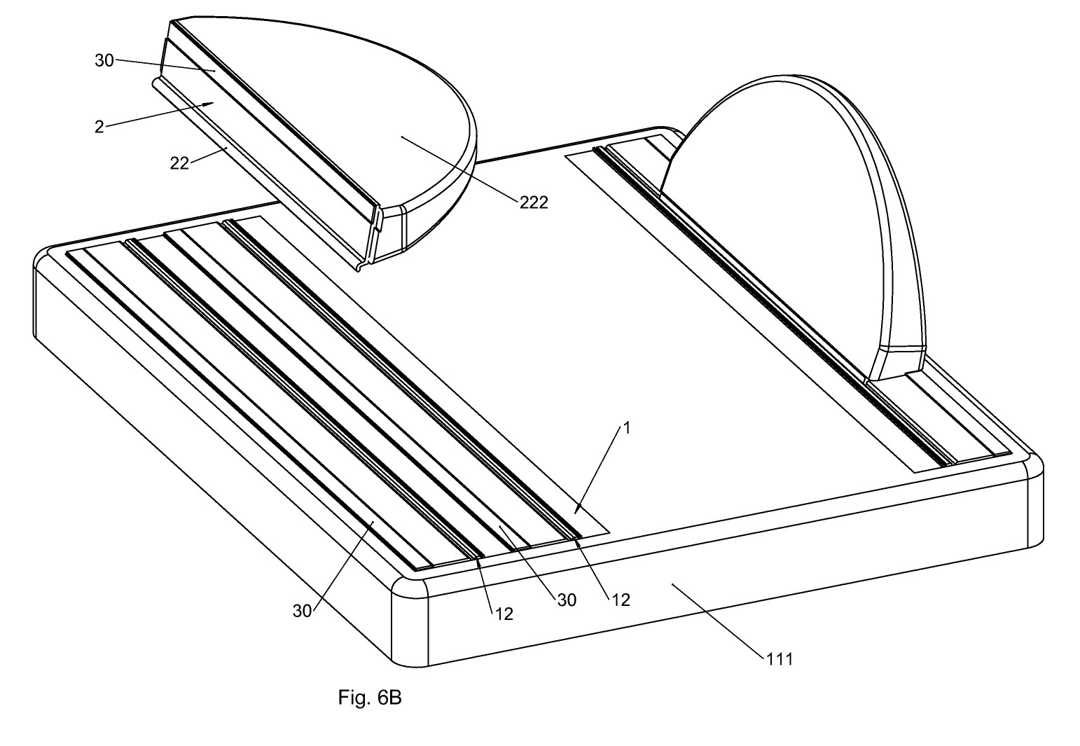

According to yet another embodiments of the invention, shown in FIG. 6A-6B, one longitudinal base profile 1 for the base part or portion 111 can be supplied with two or more longitudinal female locking parts or sections 12, so that, in addition to the non-stepwise and/or progressively adjustable or movable or slidable function in the longitudinal direction, the adjustable part or portion 222 will have a stepwise adjustable function in the radial direction. In addition and as mentioned before, the additional fastening means 30 (e.g. Velcro™) can be arranged along the entire longitudinal direction for the base profile 1 or portion 111 and onto the entire radial width of at least one of the visible surfaces or faces of the longitudinal base plate parts or sections (FIG. 6A). As shown in FIG. 6B, several of the visible surfaces or faces of the longitudinal base plate parts or sections can be adapted for two or more additional fastening means 30 (e.g. Velcro™) onto at least some or the entire radial width thereof. For example, when the locking parts or sections 12 of the longitudinal base profile 1 for the base part or portion 111 are substantially close to each other in relation to the width of the adjustable profile 2 or the adjustable part or portion 222, it would be sufficient to have the additional fastening means 30 (e.g. Velcro™) arranged along the entire longitudinal direction for the base profile 1 or portion 111 and onto the entire radial width of only one of the visible surfaces or faces of the longitudinal base plate parts or sections, in this case the surface having the biggest surface area and being on the left side in FIG. 6A. However, if the locking parts or sections 12 of the longitudinal base profile 1 for the base part or portion 111 are arranged with a certain distance between each other in comparison with the width of the adjustable profile 2 or the adjustable part or portion 222, then it would be necessary to arrange extra additional fastening means 30 onto the visible surface or face of the longitudinal base plate part or section being situated between the locking parts or sections 12, as it is shown in FIG. 6B.

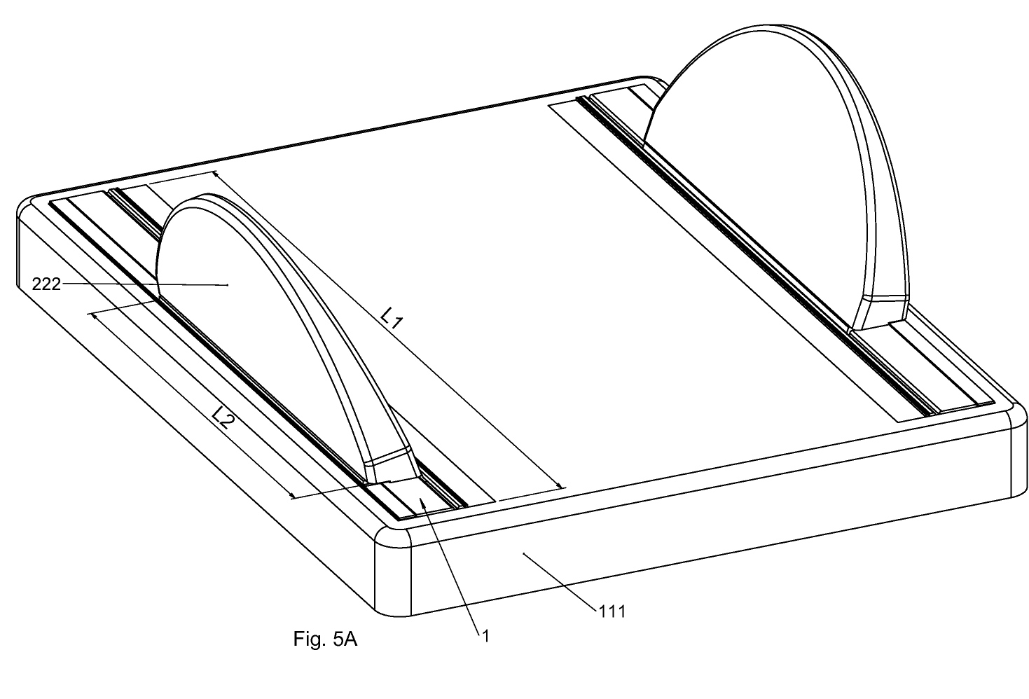

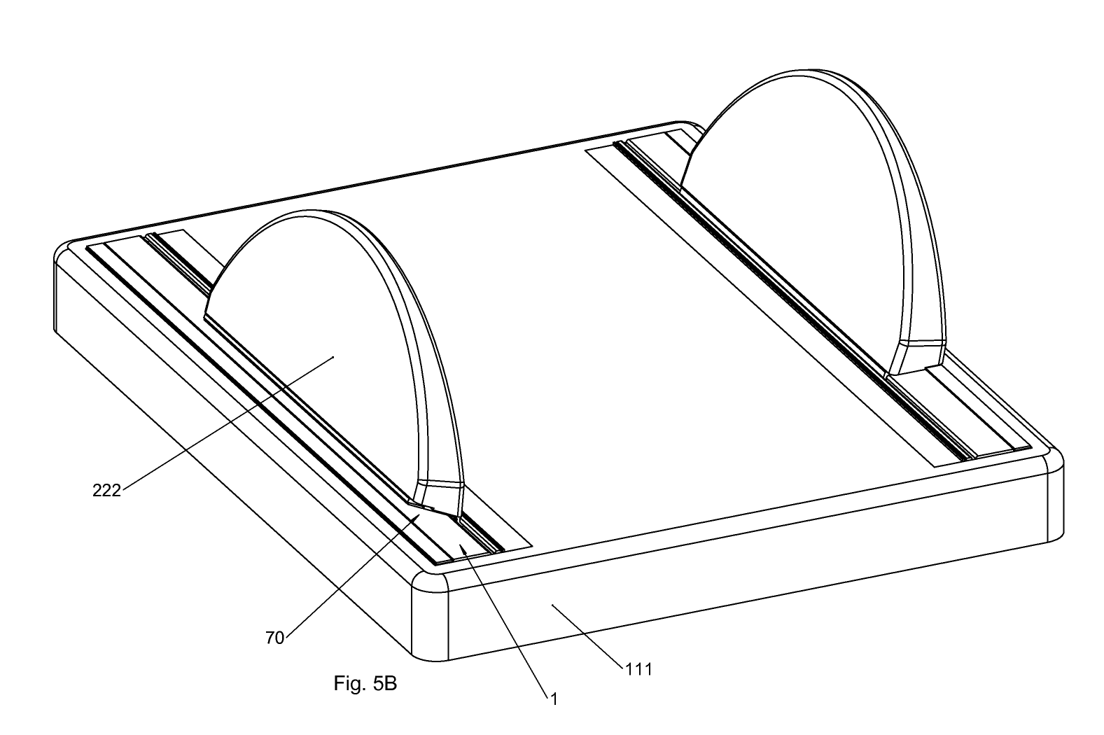

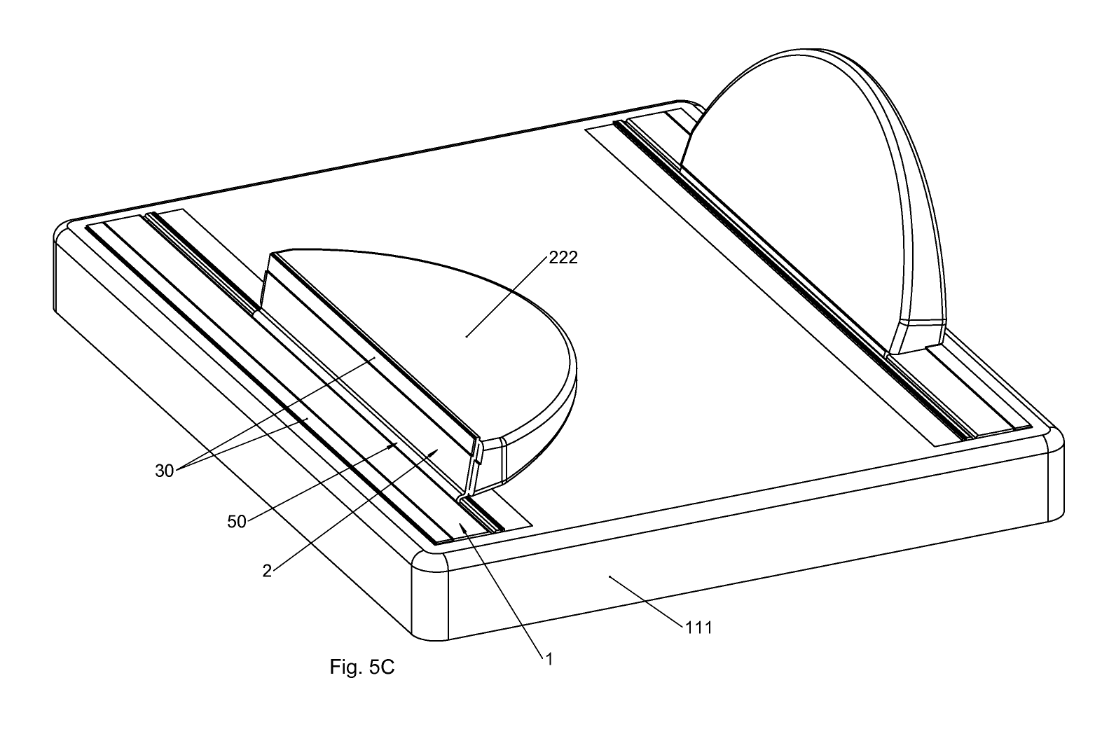

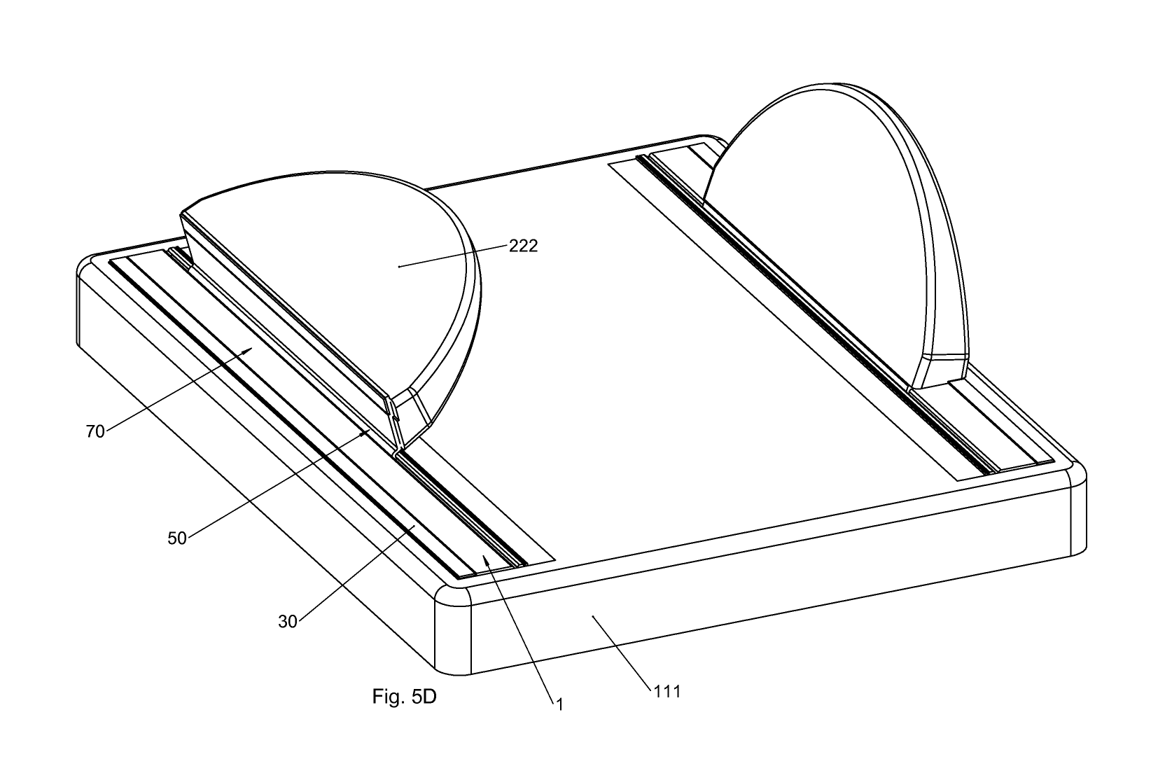

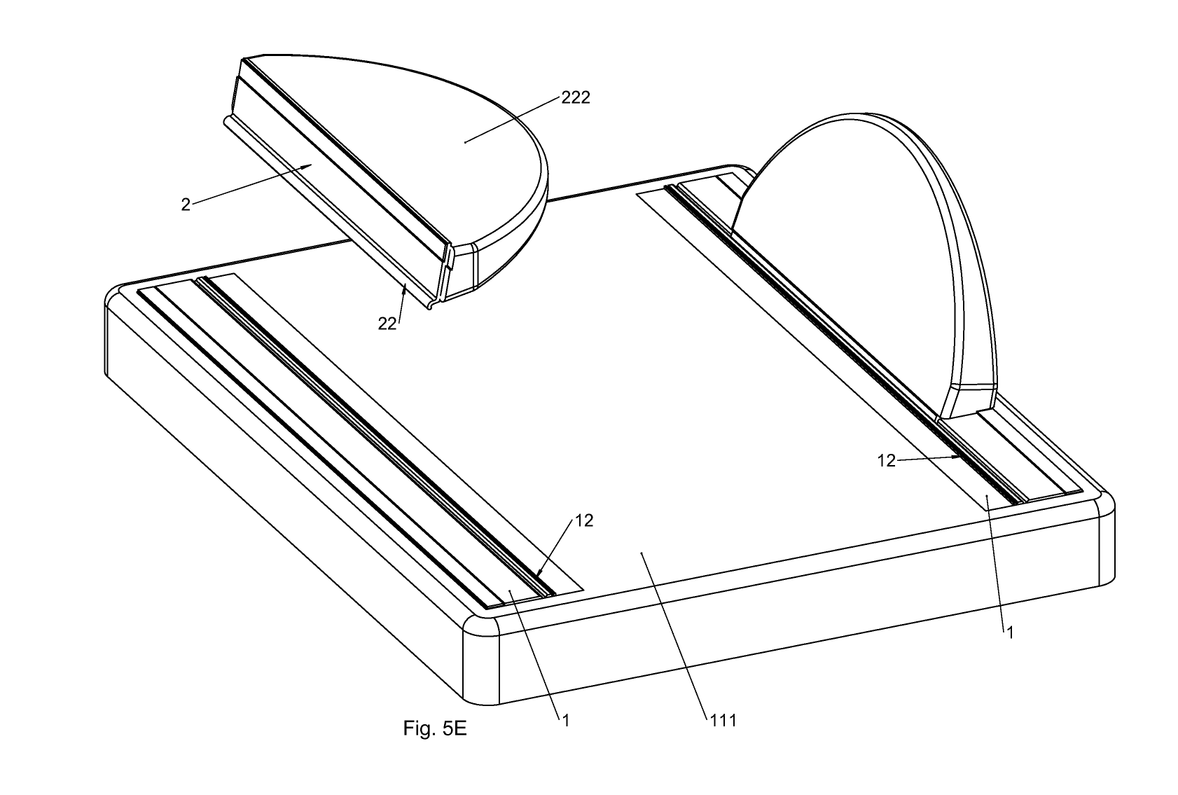

According to a further embodiment of the invention the base part or portion 111 can be supplied with two or more longitudinal base profiles 1, so that two or more adjustable parts or portions 222 can be mounted or arranged onto one base part or portion 111 (see FIG. 5D).

According to yet another further embodiment of the invention the female and male longitudinal profiles 1, 2 can be switched in relation to the base and the adjustable parts or portions 111, 222, so that the female longitudinal profile 1 comprising the female locking part or section 12 can be arranged on(to) the adjustable part or portion 222, and the male longitudinal profile 2 comprising the male locking part or section 22 can be arranged on(to) the base part or portion 111.

In addition, at least one of the longitudinal profiles 1, 2 can further comprise at least one stress-resisting or reinforcement portion d1, d2, d3 arranged in the connection area between the locking part or section 12, 22 and the longitudinal plate part or section 11, 13, 23, wherein said at least one stress-resisting or reinforcement portion d1, d2, d3 is having a raised area or portion d1, d2, d3 on at least one side of the longitudinal plate part or section 11, 13, 23, thus providing for the stability and rigidness of the longitudinal profiles 1, 2. As shown in FIG. 1A, the longitudinal plate part or section 11 has two stress-resisting or reinforcement portions d1, d2, one on each side in the connection area to the longitudinal female locking part or section 12, while the other longitudinal plate part or section 13, which is one part of the facing ones, has only one stress-resisting or reinforcement portion d3 in the connection area to the longitudinal female locking part or section 12, wherein the other side, f, is rounded. According to different embodiments, the stress-resisting or reinforcement portions d1, d2, d3, etc. can have substantially quadrangular/rigid or substantially rounded shapes or forms or edges, wherein said shapes or forms or edges can be calculated and/or chosen depending on the stress or tension level in each connection area.

As shown in FIG. 2A-2D, the locked, loose or sliding and open positions for the adjustable fixation or locking means 70 can be defined by the angle, alpha/α, formed between the plate parts or sections 13, 23 of the longitudinal profiles 1, 2, that are facing each other, where the center for the angle is defined by the connected female and male locking parts or sections 12, 22, in other words the center defined by the sliding hinge means 50.

In the adjustable fixation or locking means 70, the locked position, shown in FIG. 2C, is defined when the angle, alpha/α, is substantially about 0 degree. The loose or sliding position, shown in FIG. 2A, is defined when the angle, alpha/α, is substantially from about 0 and to about 45 degrees. The open position, shown in FIG. 2D, is defined when the angle, alpha/α, is substantially bigger or greater than about 45 degrees, in this case the angle, alpha/α, is about 90 degrees.

According to one embodiment of the invention, the male locking part or section 22 can be made slightly smaller than the female locking part or section 12 with a negative thickness margin of between about 0.1 and about 0.3 mm, thus facilitating good and easy longitudinal slidability or movability of the adjustable longitudinal profile 2 in relation to the base longitudinal profile 1, thus providing for good and easy non-stepwise and/or progressively adjustable regulation of said two parts or portions 111, 222 in relation to each other.

According to another embodiment of the invention, the top or end part, i, of the male locking part or section 22 can be made slightly higher than the corresponding top bottom part, a, of the female locking part or section 12 with a positive margin of between about 0.1 and about 0.3 mm, thus providing for the firm connection between the longitudinal profiles 1, 2 when in locked position (see FIG. 1A-1B and FIG. 2B-2C). When the each other facing longitudinal plate parts or sections 13, 23 of the longitudinal profiles 1, 2 are not strained e.g. by the additional fastening means 30 there will be provided a very small relaxing angle, alphaᵣ/αᵣ, from about 0.1 to about 5 degrees depending on the size of above-mentioned positive margin for the top or end part, i, of the male locking part or section 22 in relation to the top bottom part, a, of the female locking part or section 12, wherein the relaxing angle, alphaᵣ/αᵣ, is about 3 degrees in the embodiment shown in FIG. 2B.

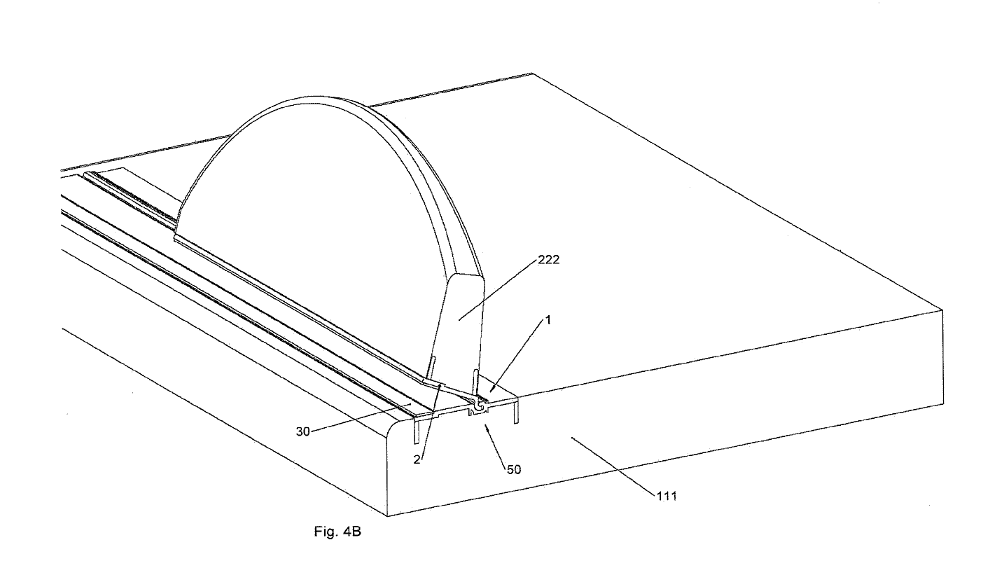

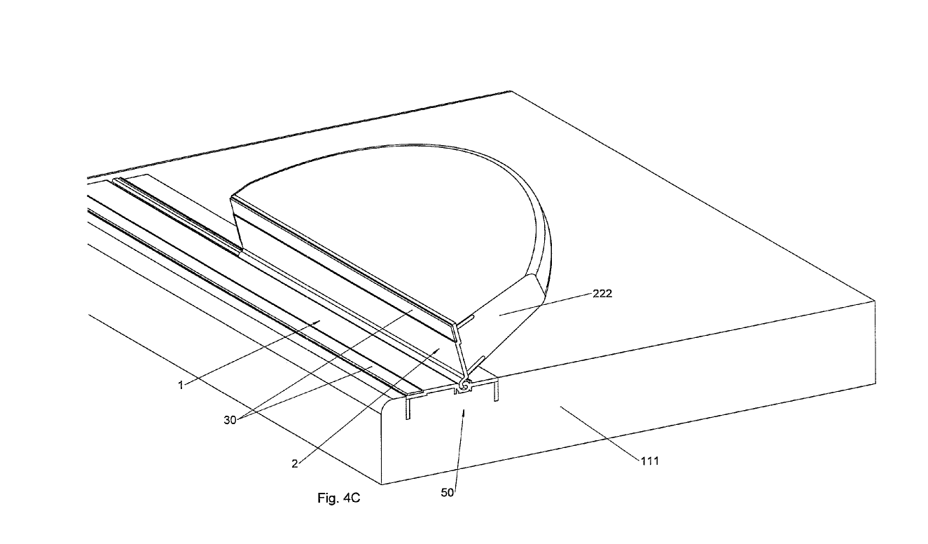

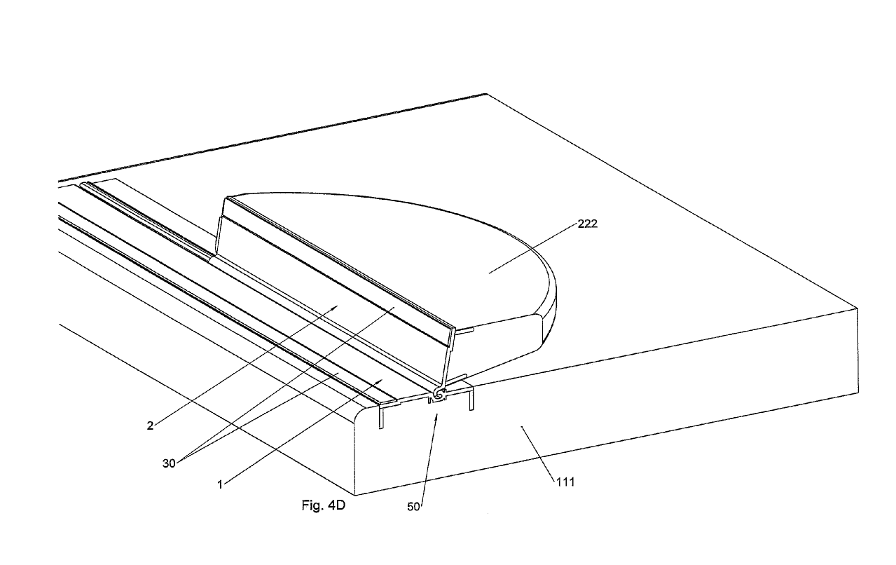

The longitudinal profiles 1, 2 can be arranged into or onto said two parts or portions 111, 222 e.g. by embedding or casting or moulding or stapling or gluing or screwing or the like, so that with regard to the longitudinal base profile 1 only one face or surface of said at least one longitudinal plate part or section 11, 13 and at least the entry of the longitudinal female locking part or section 12 will be visible; and with regard to the adjustable longitudinal profile 2 only one face or surface of the longitudinal plate part or section 23 and the longitudinal male locking part or section 22 will be visible. See for example FIGS. 4C, 4D, 5C and 5D.

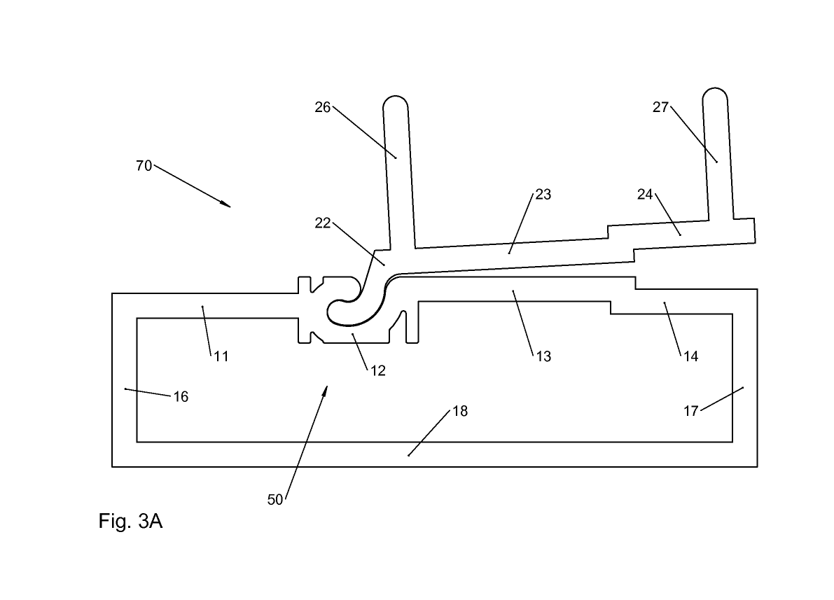

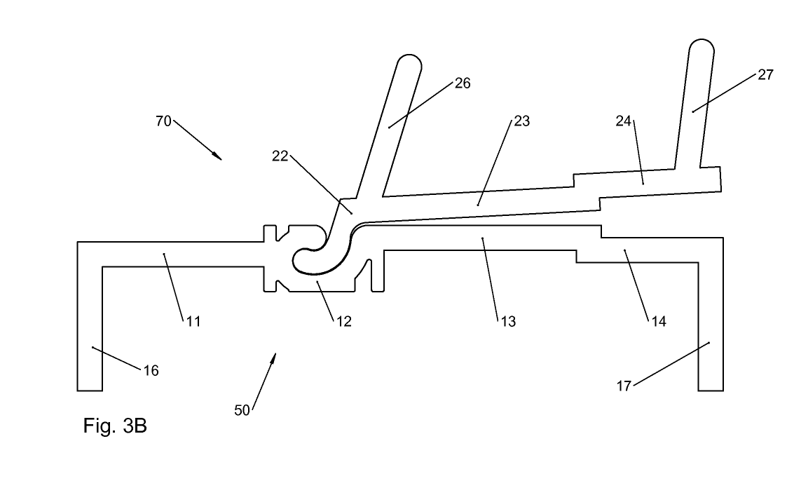

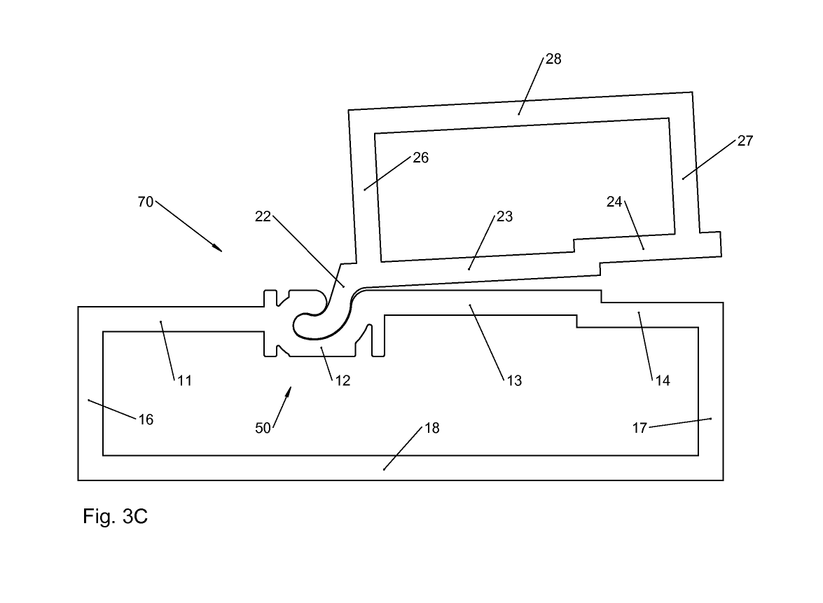

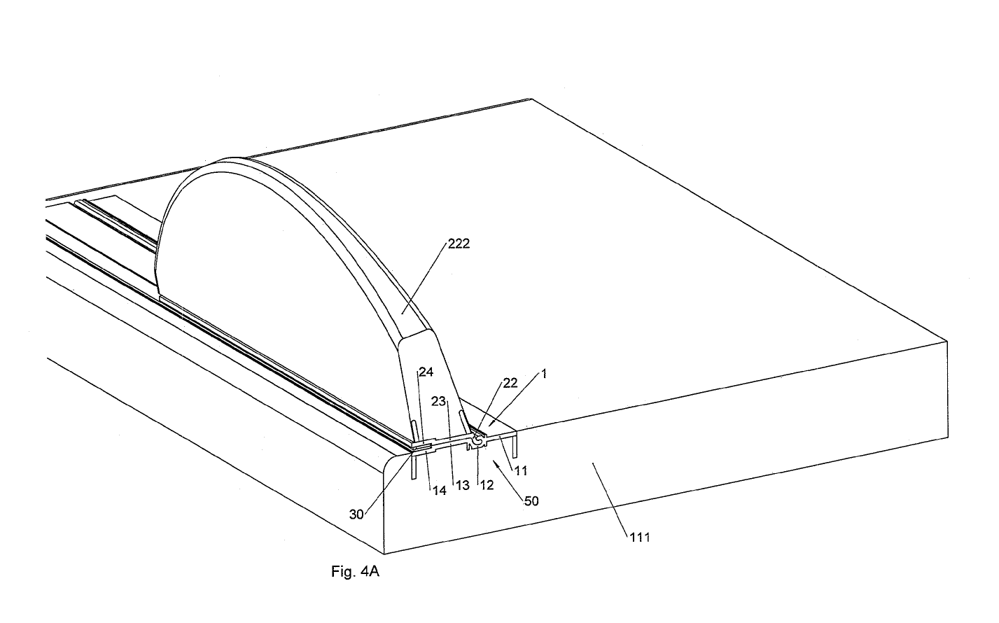

FIG. 3A-3C show radial cross-sections of different embodiments the fixation or locking means 70 according to the present invention, wherein one or both of the longitudinal profiles 1, 2 can further comprise at least one supporting part or section 16, 17, 26, 27 being connected to and substantially perpendicular to (e.g. FIGS. 3A and 3C) or having at least one predetermined angle (e.g. FIG. 3B) with regard to at least one longitudinal plate part or section 11, 13, 23 (possibly 14, 24), thus providing for the stability and rigidness of the longitudinal profiles 1, 2 for said two parts or portions 111, 222. Said at least one predetermined angle for said at least one supporting part or section 16, 17, 26, 27 can be determined with regard to the respective form or shape of the respective part or portion 111, 222. In addition, according to different embodiments (e.g. FIGS. 3A and 3C), at least one additional supporting part or section 18, 28 can be connected to said at least one supporting part or section 16, 17, 26, 27 forming thus a closed loop (see: i) 11, 12, 13, possibly 14, 17, 18, 16, and ii) 23, 24, 27, 28, 26 in FIGS. 3A and 3C), thus providing for the stability and rigidness of the longitudinal profiles 1, 2 for said two parts or portions 111, 222.

The two parts or portions 111, 222 can be different furniture and/or human necessity (e.g. for wheelchairs) elements of such latter products. According to one embodiment of the invention the base part or portion 111 can be a back part or backrest and the adjustable part or portion 222 can be a side support or cushion part, e.g. for an arm or a shoulder of a person or a patient. The profiles 1, 2 for the fixation or locking means 70 of the two parts or portions 111, 222 can be made of e.g. extruded semi-hard PVC. What is important here is that the profiles 1, 2 should have suitable elastic properties allowing for sufficient elasticity or flexibility of the female 12 and male 22 locking parts or sections, so that they will not break easily. The elements of the profiles 1, 2 should also have a sufficient hardness, providing for the firm connection between the two parts or portions 111, 222. Additional suitable materials providing for the desired flexibility and/or hardness can also be used, e.g. other plastic materials. The material of the base profile 1 can be the same as the material of the adjustable profile 2. Alternatively, different materials can be used for each profile. The profiles 1, 2 can be integrated or incorporated onto or into the two parts or portions 111, 222, respectively, wherein the two parts or portions 111, 222 can be made of e.g. polyurethane foam plastic. Other suitable materials for the two parts or portions 111, 222 can also be used.

As shown in FIG. 5A, the longitudinal base profile 1 can have a chosen length L1 being predetermined or defined by the base part or portion 111, wherein said chosen length L1 is longer or bigger than a certain length L2 of the adjustable longitudinal profile 2, which certain length L2 is being predetermined or defined by the adjustable part or portion 222, and wherein the adjustable longitudinal profile 2 for the adjustable part or portion is firmly fixed or connected to the longitudinal base profile 1 for the base part or portion 111 when in closed position; the adjustable longitudinal profile 2 for the adjustable part or portion 222 being in the longitudinal direction non-stepwise and/or progressively adjustable or movable or slidable in relation to the longitudinal base profile 1 for the base part or portion 111 when in loose or sliding position, as shown in FIGS. 5B and 5C, thus providing for a non-stepwise or progressively regulation and allowing for numerous positions for the adjustable part or portion 222 in relation to the base part or portion 111; and the adjustable longitudinal profile 2 for the adjustable part or portion 222 being detachable or separated (shown in FIG. 5E) from the longitudinal base profile 1 for the base part or portion 111 when in open position, as shown in FIG. 5C.

FIG. 4A-4D show in detail and in perspective a cross-sectional view of the different steps or positions for the two parts or portions 111, 222 incorporating the fixation or locking means 70 according to one embodiment of the present invention. For example, in order to slide or move the adjustable part or portion 222 from the position shown in FIG. 5A to the position shown in FIG. 5D, there are several steps that must be performed. From the closed position shown in FIG. 4A, the fixation or locking means 70 should be put in the loose or sliding position shown in FIG. 4B in order to non-stepwise and/or progressively move or slide the adjustable part or portion 222 in relation to the base part or portion 111 to the position shown in FIG. 5D. When the angle, alpha/α, between the profiles 1, 2, as shown in FIG. 4C, is slightly bigger or greater than about 45 degrees, the two parts or portions 111, 222 can be detached or separated from each other. Of course the two parts or portions 111, 222 could also be moved or glided or slid in relation to each other, but then the possibility of getting them 111, 222 separated or detached is quite big. When the angle, alpha/α, between the profiles 1, 2, as shown in FIG. 4D, is about 90 degrees or even more, the two parts or portions 111, 222 can be detached or separated from each other quite easily, as shown in FIG. 5E.

It should be noted that alternative embodiments, not mentioned herein but falling within the range of the patent claims, are also to be considered as part of the present invention.

1. Furniture element comprising two parts or portions (111, 222) and an adjustable fixation or locking means using sliding hinge means, wherein the fixation or locking means comprises a longitudinal base profile (1) comprising a longitudinal female locking part or section (12) connected to at least one longitudinal plate part or section (11, 13) and an adjustable longitudinal profile (2) comprising a longitudinal male locking part or section (22) connected to a longitudinal plate part or section (23), the longitudinal female locking part or section (12) and the longitudinal male locking part or section (22) defining the sliding hinge means, wherein the fixation or locking means has three positions: a locked, a loose or sliding and an open position, wherein the longitudinal base profile (1) has a chosen length (L1) being predetermined or defined by the base part or portion (111), said chosen length (L1) being longer or bigger than a certain length (L2) of the adjustable longitudinal profile (2) being predetermined or defined by the adjustable part or portion (222), and wherein the adjustable longitudinal profile (2) for the adjustable part or portion (222) is firmly fixed or connected to the longitudinal base profile (1) for the base part or portion (111) when in closed position; the adjustable longitudinal profile (2) for the adjustable part or portion (222) being in the longitudinal direction non-stepwise and/or progressively adjustable or movable or slidable in relation to the longitudinal base profile (1) for the base part or portion (111) when in loose or sliding position thus providing for a non-stepwise or progressively regulation and allowing for numerous positions for the adjustable part or portion (222) in relation to the base part or portion (111); and the adjustable longitudinal profile (2) for the adjustable part or portion (222) being detachable or separated from the longitudinal base profile (1) for the base part or portion (111) when in open position.

2. Furniture element according to claim 1, wherein the longitudinal female locking part or section (12) is a groove or recess having a radial cross-section with a substantially J-shape or a shape substantially being in the form of a lower part of a hook; the longitudinal male locking part or section (22) is a tongue having a radial cross-section with a shape substantially corresponding to the shape of the longitudinal female locking part or section (12) and geometrically fittable therein.

3. Furniture element according to claim 1, wherein the locked, loose or sliding and open positions are defined by the angle (alpha/α) formed between the plate parts or sections (13, 23) of the longitudinal profiles (1, 2) that are facing each other, where the center for the angle is defined by the connected female and male locking parts or sections (12, 22).

4. Furniture element according to claim 3, wherein the locked position is defined when the angle (alpha/α) is substantially about 0 degree; the loose or sliding position is defined when the angle (alpha/α) is substantially between about 0 and about 45 degrees; and the open position is defined when the angle (alpha/α) is substantially bigger or greater than about 45 degrees.

5. Furniture element according to claim 1, wherein the each other facing plate parts or sections (13, 23) of the longitudinal profiles (1, 2) are each having on its end, that is opposite to the sliding hinge means, a recessed part or section (14, 24) providing for sufficient room or space (15, 25) for rooming an additional fastening means (30) being easily fastened or unfastened, preferably without the necessity of any tool or tools.

6. Furniture element according to claim 5, wherein the additional fastening means is at least one of: Velcro™, zipper, clamps, clips, or the like.

7. Furniture element according to claim 1, wherein the male locking part or section (22) is made slightly smaller than the female locking part or section (12) with a negative thickness margin of between about 0.1 and about 0.3 mm, thus facilitating good and easy longitudinal slidability or movability of the adjustable longitudinal profile (2) in relation to the base longitudinal profile (1).

8. Furniture element according to claim 1, wherein the top or end part (i) of the male locking part or section (22) is made slightly higher than the corresponding top bottom part (a) of the female locking part or section (12) with a positive margin of between about 0.1 and about 0.3 mm, thus providing for the firm connection between the longitudinal profiles (1, 2) when in locked position.

9. Furniture element according to claim 1, wherein the longitudinal profiles (1, 2) are arranged into or onto said two parts or portions (111, 222), e.g. by embedding or casting or moulding or stapling or gluing or screwing or the like, so that with regard to the longitudinal base profile (1) only one face or surface of said at least one longitudinal plate part or section (11, 13) and at least the entry of the longitudinal female locking part or section (12) will be visible; and with regard to the adjustable longitudinal profile (2) only one face or surface of the longitudinal plate part or section (23) and the longitudinal male locking part or section (22) will be visible.

10. Furniture element according to claim 1, wherein at least one of the longitudinal profiles (1, 2) further comprise at least one stress-resisting or reinforcement portion (d1, d2, d3) arranged in the connection area between the locking part or section (12, 22) and the longitudinal plate part or section (11, 13, 23), said at least one stress-resisting or reinforcement portion (d1, d2, d3) having a raised area or portion (d1, d2, d3) on at least one side of the longitudinal plate part or section (11, 13, 23), thus providing for the stability and rigidness of the longitudinal profiles (1, 2).

11. Furniture element according to claim 1, wherein the longitudinal profiles (1, 2) further comprise at least one supporting part or section (16, 17, 26, 27) being connected to and substantially perpendicular to or having a predetermined angle with at least one longitudinal plate part or section (11, 13, 23), thus providing for the stability and rigidness of the longitudinal profiles (1, 2) for said two parts or portions (111, 222).

12. Furniture element according to claim 11, wherein at least one additional supporting part or section (18, 28) is connected to said at least one supporting part or section (16, 17, 26, 27) forming a closed loop, thus providing for the stability and rigidness of the longitudinal profiles (1, 2) for said two parts or portions (111, 222).

13. Furniture element according to claim 1, wherein the two parts or portions (111, 222) and the adjustable fixation or locking means are elements or parts in a furniture product, such as e.g. a chair, sofa, etc., or in a human necessity product, such as e.g. a wheelchair, etc.

14. Furniture element according to claim 2, wherein the locked, loose or sliding and open positions are defined by the angle (alpha/α) formed between the plate parts or sections (13, 23) of the longitudinal profiles (1, 2) that are facing each other, where the center for the angle is defined by the connected female and male locking parts or sections (12, 22).

15. Furniture element according to claim 14, wherein the locked position is defined when the angle (alpha/α) is substantially about 0 degree; the loose or sliding position is defined when the angle (alpha/α) is substantially between about 0 and about 45 degrees; and the open position is defined when the angle (alpha/α) is substantially bigger or greater than about 45 degrees.

16. Furniture element according to claim 2, wherein the each other facing plate parts or sections (13, 23) of the longitudinal profiles (1, 2) are each having on its end, that is opposite to the sliding hinge means, a recessed part or section (14, 24) providing for sufficient room or space (15, 25) for rooming an additional fastening means (30) being easily fastened or unfastened, preferably without the necessity of any tool or tools.

17. Furniture element according to claim 3, wherein the each other facing plate parts or sections (13, 23) of the longitudinal profiles (1, 2) are each having on its end, that is opposite to the sliding hinge means, a recessed part or section (14, 24) providing for sufficient room or space (15, 25) for rooming an additional fastening means (30) being easily fastened or unfastened, preferably without the necessity of any tool or tools.

18. Furniture element according to claim 4, wherein the each other facing plate parts or sections (13, 23) of the longitudinal profiles (1, 2) are each having on its end, that is opposite to the sliding hinge means, a recessed part or section (14, 24) providing for sufficient room or space (15, 25) for rooming an additional fastening means (30) being easily fastened or unfastened, preferably without the necessity of any tool or tools.

19. Furniture element according to claim 14, wherein the each other facing plate parts or sections (13, 23) of the longitudinal profiles (1, 2) are each having on its end, that is opposite to the sliding hinge means, a recessed part or section (14, 24) providing for sufficient room or space (15, 25) for rooming an additional fastening means (30) being easily fastened or unfastened, preferably without the necessity of any tool or tools.

20. Furniture element according to claim 15, wherein the each other facing plate parts or sections (13, 23) of the longitudinal profiles (1, 2) are each having on its end, that is opposite to the sliding hinge means, a recessed part or section (14, 24) providing for sufficient room or space (15, 25) for rooming an additional fastening means (30) being easily fastened or unfastened, preferably without the necessity of any tool or tools.
